(19) United States
(12) Patent Application Publication
(10) Pub. No.: US 2014/0179520 A1
(43) Pub. Date: Jun. 26, 2014

(54) Humic Acid Composition

(71) Applicant: Brandt Consolidated, Inc., Springfield, IL (US)

(72) Inventor: Brian R. Haschemeyer, Athens, IL (US)

(73) Assignee: Brandt Consolidated, Inc., Springfield, IL (US)

(21) Appl. No.: 14/107,011

(22) Filed: Dec. 16, 2013

Related U.S. Application Data
(60) Provisional application No. 61/740,714, filed on Dec. 21, 2012.

(51) Int. Cl. C05B 17/00; C05G 3/02; C05C 11/00; C05F 11/00

(52) U.S. Cl. CPC C05B 17/00; C05F 11/00; C05G 3/02; C05C 11/00
USPC 504/101; 71/24; 504/116.1

(57) ABSTRACT

A humic acid composition useful as a fertilizer contains about 0.1 to 25 parts by weight humic acid dissolved in about 75 to 99.9 parts by weight of a solvent. The solvent contains at least one nonaqueous solvent. The composition has a pH of about 1 to 7 and a RED of less than about 1.0.

### CROSS-REFERENCE TO RELATED APPLICATION

This application claims the benefit of U.S. Provisional Application Ser. No. 61/740,714, Dec. 21, 2012.

### FIELD OF THE INVENTION

This invention relates to agriculture. More particularly, this invention relates to humic acid compositions that are added to the soil or directly to plants or seeds to improve the growth of plants.

### BACKGROUND OF THE INVENTION

1. Soil Additives

Soil additives (also known as soil amendments) are materials that are added to the soil to improve the growth of plants. Soil additives are sometimes divided into two classes: soil conditioners and fertilizers.

2. Soil Conditioners

Soil conditioners are materials that improve the physical qualities of the soil, such as its structure, water retention qualities, and its pH (a measure of the acidity or alkalinity of an aqueous solution). The pH of pure water is 7 and is considered neutral. Solutions having a pH less than 7 are acidic and solutions having a pH greater than 7 are alkaline. For acidic solutions, the pH decreases as the acidity increases. For alkaline solutions, the pH increases as the alkalinity increases. Common soil conditioners include compost, peat, straw, and lime (calcium oxide).

3. Fertilizers

Fertilizers are materials that provide one or more of thirteen essential elements for plant growth. Sixteen elements are known to be essential for plant growth. Three of the essential elements, carbon, hydrogen, and oxygen, are provided by carbon dioxide and water. Carbon dioxide is present in the atmosphere and water is present in both the atmosphere and the soil. Three of the other essential elements, nitrogen, phosphorus, and potassium, are needed by plants in relatively large amounts and are commonly known as the macronutrients. Another three of the essential elements, calcium, magnesium, and sulfur, are required in lesser amounts and are commonly known as the secondary nutrients. Seven of the essential elements, iron, manganese, copper, zinc, molybdenum, chlorine, and boron, are required in very small amounts and are commonly known as the micronutrients.

Commercial fertilizers typically contain many different elements and the elements are typically in the form of compounds. For example, calcium phosphate is commonly used in fertilizers to provide both calcium and phosphorus. Commercial fertilizers are often produced and applied in the form of acidic aqueous (water based) solutions. A solution is a uniformly dispersed mixture at the molecular level of one or more substances (known as the solute) in one or more other substances (known as the solvent). Commercial fertilizers are usually applied to the soil but are sometimes applied by spraying directly onto the leaves of the growing plants (known as foliar feeding) or applied to the seeds before planting. When dissolved in an aqueous solution, many compounds dissociate into cations (positively charged ions) and anions (negatively charged ions). In the example of calcium phosphate, dissociation results in calcium cations and phosphate anions in the solution.

4. Solubility and the Dielectric Constant

In formulating commercial fertilizers as aqueous solutions, the solubility of the various components must be considered. If a solid component fails to dissolve, the solid particles tend to obstruct irrigation lines and spray nozzle filters. The solid particles also tend to remain at the bottom of tanks rather than being applied to the soil. If a liquid component is insoluble in water, the resulting formulation tends to separate into two or more heterogeneous phases.

The solubility of a solute in a solvent depends on many atomic and molecular interactions. A great deal of research has been conducted in predicting solubility based on physical constants of the particular solute and solvent. One approach has been to use the dielectric constant of the solute and solvent.

The solubility of compounds is related to the distribution of electrical charges on a molecular level. Compounds having a very uneven distribution of electrical charges are referred to as polar, compounds having a slightly uneven distribution of electrical charges are referred to as semi-polar, and compounds having an even distributions of electrical charge are referred to as nonpolar. The polarity of a compound is quantified by its dielectric constant (also known as its relative static permittivity).

Polar liquids tend to have a high dielectric constant. For example, the water molecule (H₂O) is polar with a negative electrical charge at the oxygen atom and a positive electrical charge at the hydrogen atoms. It follows that water has a relatively high dielectric constant of 80. By contrast, nonpolar liquids tend to have a low dielectric constant. For example, the benzene molecule (C₆H₆) has an even distribution of electrical charge and has a relatively low dielectric constant of 2.3.

The dielectric constant of a solution can be estimated by summing each component's volume percentage multiplied by its individual dielectric constant. For example, the dielectric constant for a solution containing 75 volume percent of a component A having a dielectric constant of 50 and 25 volume percent of a component B having a dielectric constant of 10 is estimated at 40 as calculated below.

Estimated Dielectric Constant of Solution=(0.75)(50)+(0.25)(10)=40

The general rule is that liquids having similar dielectric constants (and similar polarities) tend to be more soluble with each other than liquids having very different dielectric constants (and different polarities). Unfortunately, many exceptions to the general rule are observed. As a result, other approaches to predicting solubility have been proposed.

4. Solubility and the Hansen Solubility Parameters

An approach to predicting solubility that was first proposed by Charles Hansen in 1967 has gained increasing acceptance in the scientific community. Hansen defined a set of three parameters for each molecule, solute or solvent:

δ_{d} the energy from dispersion forces between molecules

δₚ the energy from dipolar intermolecular forces between molecules

δₕ the energy from hydrogen bonds between molecules

The symbol for the lower case Greek letter delta is used for these three Hansen energy parameters. The energy parameters are expressed as energy density (energy per volume) to the one-half power. In the International System of Units (SI), the Hansen solubility parameters are commonly given in units of Joules per cubic centimeter to the one-half power, abbreviated as (J/cm³)^{0.5}. The energy parameters are also expressed in units of pressure (force per area) to the one-half power. An additional parameter, R₀ the interaction radius, was defined for a solute. All four of the Hansen solubility parameters must be determined experimentally. The energy parameters for thousands of compounds have been published. For solvents containing multiple components, the parameters for the system are estimated by summing each component's volume percentage multiplied by its individual parameter.

With the three parameters known for a solvent 2 and a solute 1, a distance Ra is calculated as follows:

(Ra)²=4(δ_{d2}−δ_{d1})²+(δₚ₂−δₚ₁)²+(δₚ₂−δₚ₁)²

A relative energy density (abbreviated as RED) is then calculated as follows using a known value for the R₀ (interaction radius) of the solute:

RED=Ra/R₀

The solubility of the solute in the solvent can then be predicted based on the value of RED as follows:

If RED<1 (less than 1), the solute and solvent are alike and the solute will dissolve in the solvent,

If RED=1, the solute and the solvent are similar and the solute will partially dissolve, and

If RED>1 (greater than 1), the solute and solvent are different and the solute will not dissolve in the solvent.

5. Humic Acid

Humic acid is a principal component of materials such as peat and coal that are formed by the biodegradation of organic matter. Humic acid is a complex mixture of many different solid compounds having a structure similar to the following:

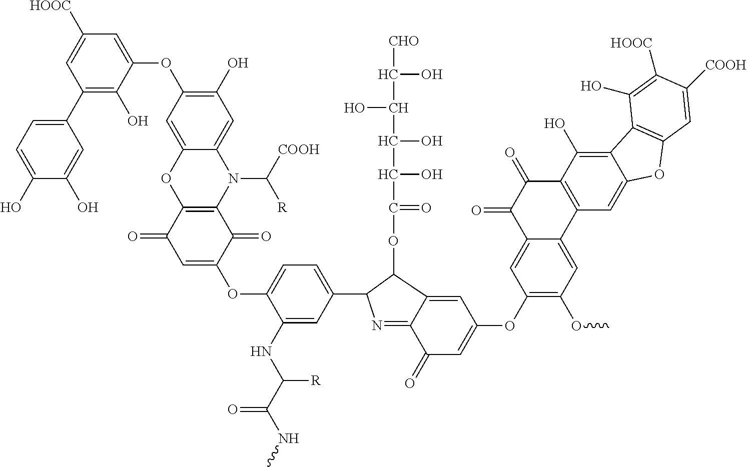

Although humic acid is a mixture of solid compounds, the individual compounds have such similar properties that the mixture can be considered a single compound for most purposes. Humic acid is known to be a beneficial soil additive. Studies have shown that humic acid improves nutrient uptake from the soil, improves water availability and drought resistance, improves soil microbial activity, etc. Unfortunately, humic acid cannot be used or co-formulated with many commercial fertilizers, pesticides, adjuvants, plant growth regulators, and other beneficial substances for plants because it has limited solubility in acidic aqueous solutions and in solutions containing calcium, iron, magnesium, manganese, or zinc ions. As a result, humic acid must often be shipped and applied separately as an alkaline aqueous solution.

Accordingly, there is a demand for a humic acid composition that has improved solubility in acidic aqueous solutions and in solutions containing calcium, iron, magnesium, manganese, or zinc ions.

### SUMMARY OF THE INVENTION

The general object of this invention is to provide a humic acid composition that has improved solubility in acidic aqueous solutions and in solutions containing calcium, iron, magnesium, manganese, or zinc ions.

I have invented an humic acid composition. The composition comprises a solution of about 0.1 to 25 parts by weight humic acid dissolved in about 75 to 99.9 parts by weight of a solvent. The solvent comprises at least one nonaqueous solvent. The composition has a pH of about 1 to 7 and a RED (relative energy density) of less than about 1.0. The solvent preferably comprises water. A variety of components are optional.

The humic acid composition of this invention is a stable solution that can be added to common commercial fertilizers consisting of acidic aqueous solutions and/or solutions containing calcium, iron, magnesium, manganese, or zinc ions without causing the precipitation of humic acid or of any other component.

### DETAILED DESCRIPTION OF THE INVENTION

### 1. THE INVENTION IN GENERAL

This invention is a composition comprising a solution. The solute is humic acid and the solvent comprises at least one nonaqueous cosolvent. The solvent generally also comprises water. A variety of other components are optional. The composition is important commercially because it can be added to common commercial fertilizers consisting of acidic aqueous solutions and/or solutions containing calcium, iron, magnesium, manganese, or zinc ions without resulting in the precipitation of the humic acid. The invention is discussed in more detail below.

### 2. THE HUMIC ACID SOLUTE

The solute is humic acid. As discussed above, humic acid is a complex mixture of many solid compounds having similar structures that function essentially as a pure compound. Humic acid is an article of commerce and is typically sold in the form of an aqueous solution. The solution of this invention contains about 0.1 to 25, preferably about 1 to 15, parts by weight humic acid. In calculating the parts by weight of humic acid, its dry basis is used (only the actual humic acid is considered).

### 3. THE SOLVENT SYSTEM

The solvent comprises at least one nonaqueous solvent. The solvent generally additionally comprises water. The solvent preferably comprises about 10 to 99 parts by weight of at least one nonaqueous solvent and about 1 to 90 parts by weight water. The solvent most preferably comprises about 25 to 90 parts by weight of at least one nonaqueous solvent and about 10 to 75 parts by weight water. The solvent makes up about 75 to 99.9, preferably about 90 to 99, parts by weight of the solution.

Suitable nonaqueous solvents are semipolar solvents that are water soluble. They generally have a dielectric constant of about 5 to 25. The solvents are preferably relatively low in cost, readily available, and environmental friendly (relatively low in toxicity to plants and animals). Preferred solvents include polyethylene glycols, ethylene glycol, propylene glycol, alcohols (e.g., methanol, ethanol, propanol, isopropanol, and butanol), sugar alcohols (e.g., glycerol and mannitol), polyglycerols, glycol ethers, amine based solvents, amide based solvents, alkylene carbonates, organic acids (e.g., lactic acid, acetic acid, and propionic acid), and inorganic acids (e.g., phosphorous acid, phosphoric acid, sulfuric acid, and nitric acid). Polyethylene glycols are especially preferred nonaqueous solvents because of their low cost and effectiveness.

### 4. THE SOLUTION

The solution comprises the humic acid solute dissolved in the solvent system. As discussed above, the solution comprises about 0.1 to 25, preferably about 1 to 15, parts by weight humic acid and about 75 to 99.9, preferably about 85 to 99, parts by weight of the solvent.

The solution has a pH of about 1 to 7, preferably about 2 to 6.5, and most preferably about 4 to 6. The desired pH is achieved by including a suitable acid. Suitable acids are soluble, have an acid dissociation constant (pKa) of about 1 to 4.5, and have relatively low dielectric constants. Preferred acids are relatively low in cost, readily available, and environmental friendly (relatively low in toxicity to plants and animals). Preferred acids include lactic acid, phosphorus acid, phosphoric acid, acetic acid, propionic acid, malic acid, citric acid, glycolic acid, gluconic acid, glucoheptonic acid, hydrochloric acid, and nitric acid. The most preferred acids include lactic acid, phosphorus acid, phosphoric acid, acetic acid, and propionic acid because they function both as solvents and as acidifiers.

The solution has a RED (relative energy density) of less than 1.0, preferably less than about 0.9, more preferably less than about 0.8, and most preferably less than about 0.7. As discussed above, the Hansen solubility parameters of a solution can be estimated by summing each component's volume percentage multiplied by its individual parameters.

### 5. SURFACTANTS

The composition optionally contains a surfactant that improves the solubility of humic acid by micellar solubilization or by coupling action. A surfactant is a compound that reduces interfacial tensions between two liquids or between a liquid and a solid. On a molecular level, surfactants are typically large molecules containing one portion that is polar and one portion that is non-polar. The polar, water-soluble portion is sometimes referred to as hydrophilic (“water loving”) while the non-polar, water-insoluble portion is sometimes referred to as hydrophobic (“water hating”) or lipophilic (“fat loving”). Surfactants are sometimes referred to as amphiphilic because of their dual character.

Humic acid has a partially amphiphilic character. At low concentrations, humic acid components are randomly distributed in solution. At higher concentrations, the humic acid components can aggregate to form larger, pseudo-micelle structures similar to surfactants. An important property of micelles is their ability to increase the solubility of poorly soluble hydrophobic components in water. Surfactant micelles are capable of increasing the solubility of many organic molecules in water. The mechanism by which this solubilization occurs is the incorporation of organic molecules into the micelle.

Surfactants with large hydrophilic groups and small hydrophobic groups may also increase solubility of humic acid by forming mixed micellar structures with humic acids. Since the hydrophilic heads are large and their hydrophobic groups are small, they tend to form spherical rather than lamellar or liquid-crystalline structures, thus inhibiting the formation of the latter. This destruction or inhibition of the liquid crystalline phase increases the solubility of the humic acid in the aqueous phase and the capacity of its micellar solution to solubilize material.

Suitable surfactants are highly soluble in water, have a hydrophilic-lipophilic balance (HLB) greater than about 10, and are environmentally friendly (relatively low in toxicity to plants and animals). Preferred surfactants include amine ethoxylates, alkyl amine ethoxylates, amine based block copolymers, polyethylene glycol esters, alcohol ethoxylates, sorbitan fatty acid ester, ethoxylated sorbitan fatty acid esters, ethylene oxide-propylene oxide (EO-PO) block copolymers, nonylphenol ethoxylates, octylphenol ethoxylates, and the like. An especially preferred surfactant is tallow amine ethoxylate (TAEO) because of its low cost and effectiveness. The effect of the surfactants is most pronounced at a solution pH of about 4 to 6.

### 6. OTHER COMPONENTS

A variety of other components are optionally included in the composition. Components that are beneficial to the plant being treated are advantageously included. Examples of such components include fungicides, insecticides, herbicides, plant growth regulators (e.g., salicylic acid), adjuvants, antioxidants (e.g., ascorbic acid), vitamins, and amino acids. Other examples include the essential elements included in fertilizers, namely, the macronutrients (nitrogen, phosphorus, and potassium), the secondary nutrients (calcium, magnesium, and sulfur), and the micronutrients (iron, manganese, copper, zinc, molybdenum, chlorine, and boron).

### 7. USES

The humic acid composition is applied to the soil, to growing plants (known as foliar feeding), or to seeds before planting. Alternatively, the humic acid composition is added to another fertilizer composition that is then applied to the soil, plants, or seeds. For example, the humic acid composition can be added to common commercial fertilizers consisting of acidic aqueous solutions and/or solutions containing calcium, iron, magnesium, manganese, or zinc ions without causing precipitation of the humic acid.

### 8. EXAMPLES

The following examples are illustrative only. All percentages are based on weight unless indicated otherwise.

### Example 1

This example illustrates the experimental determination of the Hansen solubility parameters for humic acid.

Humic acid samples were dissolved in a large number of solvents having known Hansen solubility parameters. The humic acid solute in this example consisted of fully protonated humic acid and humic acid that were partially protonated, all proton functional groups of the humic acid with a pKa of 6.5 or greater were fully protonated. Five grams of humic acid were added to 100 ml of a solvent at room temperature for 48 hours. After 48 hours the solvents were scored 1 if the humic acid dissolved in the solvent and 0 if no humic acid was dissolved. The Hansen solubility parameter values of the solvents were then plotted three dimensionally with respect to δ_{d}, δₚ and δₕ to determine the solubility sphere. The Hansen solubility parameters (δ_{d}, δₚ and δₕ) for the humic acid are the coordinates for the center of solubility sphere. The R₀ (interaction radius) of the solute is the radius of solubility sphere. The humic acid solute consisted of fully protonated humic acid. An analysis was then made for the humic acid parameters that would best fit the data. Based on this experimental work, the following parameters for humic acid were determined as shown in Table 1.

TABLE 1
Humic Acid Hansen Solubility Parameters

| Compound | δ_{d} (J/cm³)^{0.5} | δₚ(J/cm³)^{0.5} | δₕ (J/cm³)^{0.5} | R₀ |
|---|---|---|---|---|
| Humic Acid | 16.4 | 13.2 | 18.1 | 16.7 |

### Example 2

This example illustrates the effect of relative energy density (RED) on the solubility of humic acid in compositions containing polyethylene glycol and citric acid.

Seven compositions of humic acid (in the form of 65 to 70 weight percent ore) were prepared using varying amounts of water, PEG 300 (a polyethylene glycol having a molecular weight of about 300), and citric acid as shown in Table 2. The Hansen solubility parameters were calculated based on published figures for the solvents and on the values for humic acid described in Example 1. The solubility was then observed. The rate of extraction is determined by observing the darkening of the solution as the humic acid dissolves.

TABLE 2
Effect of RED on Solubility

| Composition # | 1 | 2 | 3 | 4 | 5 | 6 | 7 |
|---|---|---|---|---|---|---|---|
| PEG 300 | 5 | 10 | 20 | 30 | 40 | 50 | 60 |
| Citric Acid | 2 | 2 | 2 | 2 | 2 | 2 | 2 |
| Humic Acid Ore | 3 | 3 | 3 | 3 | 3 | 3 | 3 |
| Water | 90 | 85 | 75 | 65 | 55 | 45 | 35 |
| RED = Ra/R₀ | 1.27 | 1.20 | 1.06 | 0.92 | 0.78 | 0.64 | 0.51 |
| pH after 24 hrs | 2.4 | 2.4 | 2.4 | 2.4 | 2.5 | 2.6 | 2.6 |
| Rate of Extraction | − | − | − | + | ++ | ++++ | +++ |
| % Humic Acid extracted | 0 | 0.02 | 0.08 | 0.12 | 1.42 | 1.97 | 1.95 |

In the first three compositions having RED values greater than 1.0, the solubility of the humic acid was very small as indicated by the slow rates of extraction and by the low percentages of extracted humic acid. As the RED values decreased, the solubility of humic acid increased.

### Example 3

This example illustrates the effect of relative energy density (RED) on the solubility of humic acid in compositions containing lactic acid.

Seven compositions of humic acid (in the form of 65 to 70 weight percent ore) were prepared using varying amounts of water and lactic acid (in the form of 90 weight percent lactic acid in aqueous solution) as shown in Table 3. The Hansen solubility parameters were calculated based on published figures for the solvents and on the values for humic acid described in Example 1. The solubility was then observed.

TABLE 3
Effect of RED on Solubility

| Composition # | 11 | 12 | 13 | 14 | 15 | 16 | 17 |
|---|---|---|---|---|---|---|---|
| Lactic Acid | 30 | 40 | 50 | 60 | 70 | 80 | 90 |
| Humic Acid Ore | 3 | 3 | 3 | 3 | 3 | 3 | 3 |
| Water | 67 | 57 | 47 | 37 | 27 | 17 | 7 |
| RED = Ra/R₀ | 1.09 | 1.00 | 0.91 | 0.83 | 0.76 | 0.69 | 0.63 |
| pH after 24 hrs | 2.3 | 2.4 | 2.4 | 2.3 | 2.3 | 2.3 | 2.3 |
| Rate of Extraction | − | − | + | ++ | +++ | +++ | +++ |
| % Humic Acid | 0.1 | 0.14 | 0.9 | 1.42 | 1.89 | 1.97 | 1.98 |
| extracted | | | | | | | |

It can be seen that lactic acid is an excellent nonaqueous solvent because it both lowers the pH and the RED. As the RED decreases below 0.9, the solution gets noticeably darker as the humic acid begins to dissolve. A substantial increase in solubility is observed at RED values of less than 0.8.

### Example 4

This example illustrates the effect of pH on the solubility of humic acid in compositions containing polyethylene glycol and citric acid.

Seven compositions of humic acid (in the form of 65 to 70 weight percent ore) were prepared using varying amounts of water, PEG 300 (a polyethylene glycol having a molecular weight of about 300), and citric acid as shown in Table 4. The Hansen solubility parameters were calculated based on published figures for the solvents and on the values for humic acid described in Example 1. The solubility was then observed.

TABLE 4
Effect of RED on Solubility

| Composition # | 21 | 22 | 23 | 24 | 25 | 26 | 27 |
|---|---|---|---|---|---|---|---|
| PEG 300 | 50 | 50 | 50 | 50 | 50 | 50 | 50 |
| Citric Acid | 0 | 0.05 | 0.1 | 0.15 | 0.2 | 0.25 | 0.3 |
| Humic Acid Ore | 3 | 3 | 3 | 3 | 3 | 3 | 3 |
| Water | 47 | 46.95 | 46.9 | 46.85 | 46.8 | 46.75 | 46.7 |
| RED = Ra/R₀ | 0.66 | 0.66 | 0.66 | 0.66 | 0.66 | 0.66 | 0.66 |
| pH after 24 hrs | 7 | 6.8 | 6 | 5.4 | 4.5 | 3.4 | 3.0 |
| Rate of Extraction | − | − | − | + | ++ | +++ | +++ |
| % Humic Acid extracted | 0.05 | 0.12 | 0.13 | 0.2 | 1.2 | 1.92 | 1.91 |

It can be seen that increases in solubility of humic acid began to be observed as the pH decreased below 5. A significant increase was noted when the pH decreased below 4.5. This increase in solubility of humic acid correlates to a decrease in the charge of humic acid as a result of protonation of the humic acid carboxyl groups.

### Example 5

This example illustrates the effect of a surfactant on the solubility of humic acid in compositions containing polyethylene glycol and citric acid.

Seven compositions of humic acid (in the form of 65 to 70 weight percent ore) were prepared using varying amounts of water, citric acid, PEG 300 (a polyethylene glycol having a molecular weight of about 300), and a surfactant, tallow amine ethoxylate (TAEO) as shown in Table 5. The solubility was then observed.

TABLE 5
Effect of Surfactant on Solubility

| Composition # | 31 | 32 | 33 | 34 | 35 | 36 | 37 |
|---|---|---|---|---|---|---|---|
| PEG 300 | 30 | 30 | 30 | 30 | 30 | 30 | 30 |
| TAEO | 0 | 10 | 0 | 10 | 0 | 10 | 0 |
| Citric Acid | 0 | 0.1 | 0.1 | 0.25 | 0.25 | 0.35 | 0.35 |
| Humic Acid Ore | 3 | 3 | 3 | 3 | 3 | 3 | 3 |
| Water | 67 | 56.9 | 66.9 | 56.25 | 66.75 | 76.65 | 66.65 |
| RED = Ra/R₀ | 0.93 | 0.73 | 0.93 | 0.73 | 0.93 | 0.73 | 0.93 |
| pH after 24 hrs | 7.2 | 7.2 | 7.2 | 5.4 | 5.4 | 3.5 | 3.5 |
| Rate of Extraction | − | + | − | ++ | + | +++ | + |
| % Humic Acid extracted | 0.92 | 0.87 | 0.45 | 0.32 | 1.2 | 1.92 | 1.91 |

It can be seen that the surfactant improved the solubility of humic acid at pH 5.4, had less effect at pH 7.2, and had a negligible effect at pH 3.5.

### Example 6

This example illustrates a formulation of humic acid with ascorbic acid (vitamin C), an antioxidant. A composition of potassium humate (80 wt. % humic acid), ascorbic acid, PEG 300 (a polyethylene glycol having a molecular weight of about 300), propylene carbonate, lactic acid, and citric acid was prepared as shown in Table 6.

TABLE 6
Composition With Ascorbic Acid

| Composition # | 38 |
|---|---|
| PEG 300 | 41 |
| Propylene Carbonate | 10 |
| Potassium Humate | 6.3 |
| Water | 27.7 |
| Citric Acid | 6 |
| Lactic Acid | 5 |
| Ascorbic Acid | 4 |
| RED = Ra/R₀ | 0.48 |
| pH | 2.8 |
| % Humic Acid | 5 |

This composition provides the benefits of both ascorbic acid and humic acid in one single product. Ascorbic acid is not stable in alkaline extracted humic acid solutions that are common in the agricultural industry. The low pH of this composition insures that a high proportion of ascorbic acid remains in the protonated, uncharged form. Metals also negatively influence the preponderance of the protonated form of ascorbic acid in a solution as well as oxidation of ascorbic acid. Humic acid acts as a chelator and may therefore may provide stabilization to ascorbic acid. Humic acid also provides additional stability via UV protection and as a reducing agent.

### Example 7

This example illustrates a formulation of humic acid with salicylic acid, a plant growth regulator. A composition of potassium humate (80 wt. % humic acid), salicylic acid, PEG 300 (a polyethylene glycol having a molecular weight of about 300), tallow amine ethoxylate 15 (TAEO), citric acid, and water was prepared as shown in Table 7.

TABLE 7
Composition with Salicylic Acid

| Composition # | 39 |
|---|---|
| PEG 300 | 10 |
| TAEO | 10 |
| Potassium Humate | 10 |
| Water | 56 |
| Citric Acid | 8 |
| Salicylic Acid | 6 |
| RED = Ra/R₀ | 0.89 |
| pH | 4.0 |
| % Humic Acid | 8 |

This composition provides the benefits of both salicylic acid and humic acid in one single product. Salicylic acid is a natural compound found in plants with roles in plant growth and development, photosynthesis, transpiration, and ion uptake and transport. Salicylic acid also induces specific changes in leaf anatomy and chloroplast structure. Salicylic acid is involved in endogenous signaling, mediating in plant defense against pathogens. It plays a role in the resistance to pathogens by inducing the production of pathogenesis-related proteins. It is involved in the systemic acquired resistance (SAR) in which a pathogenic attack on one part of the plant induces resistance in other parts.

### Example 8

This example illustrates a formulation of humic acid with iron (from iron sulfate heptahydrate) and nitrogen (from urea). A composition of potassium humate (80 wt. % humic acid), iron sulfate heptahydrate (20 wt. % iron), Urea (46 wt. % nitrogen), PEG 300 (a polyethylene glycol having a molecular weight of about 300), tallow amine ethoxylate (TAEO), and citric acid was prepared as shown in Table 8

TABLE 8
Composition with Iron and Nitrogen

| Composition # | 40 |
|---|---|
| PEG 300 | 23 |
| TAEO | 5 |
| Potassium Humate | 5 |
| Water | 42 |
| Urea | 11 |
| Citric Acid | 4 |
| Ferrous sulfate heptahydrate | 10 |
| RED = Ra/R₀ | 0.81 |
| pH | 2.5 |
| % Nitrogen from Urea | 5.0 |
| % Iron (Fe) | 2.0 |
| % Humic Acid | 4.0 |

This composition provides the benefits of both iron and humic acid in one single product. The iron does not bind the carboxyl and phenolic groups of the humic acid. This, in turn, prevents the precipitation of the humic acid and/or iron humate salts. Formulations of iron and humic acid together typically involve and chelated iron to be added to alkaline extracted humic acid in an alkaline solution of water.

### Example 9

This example illustrates a formulation of humic acid with propiconazole (triazole fungicide). A composition of potassium humate (80 wt. % humic acid), propiconazole (98 wt. %), PEG 300 (a polyethylene glycol having a molecular weight of about 300), propylene carbonate, T-Mulz DP6E (a 6 mole decyl alcohol phosphate ester), citric acid, and water was prepared as shown in Table 9.

TABLE 9
Composition with Propiconazole

| Composition # | 41 |
|---|---|
| PEG 300 | 20 |
| Propylene Carbonate | 20 |
| Potassium Humate | 5 |
| Propiconazole | 4.1 |
| Water | 31.9 |
| Citric Acid | 4 |
| T-Mulz DP6E | 15 |
| RED = Ra/R₀ | 0.71 |
| pH | 4.5 |
| % Propiconazole | 4.0 |
| % Humic Acid | 4.0 |

This composition provides the benefits of both the fungicide propiconazole and humic acid in one single product.

### Example 10

This example illustrates a formulation of humic acid with azoxystrobin, a methoxyacrylate compound used as a preventive and curative systemic fungicide. A composition of potassium humate (80 wt. % humic acid), azoxystrobin (99 wt. %), PEG 300 (a polyethylene glycol having a molecular weight of about 300), propylene carbonate, tallow amine ethoxylate (TAEO), and T-Mulz DP6E, a 6 mole decyl alcohol phosphate ester was prepared as shown in Table 10.

TABLE 10
Composition with Azoxystrobin

| Composition # | 42 |
|---|---|
| Propylene Carbonate | 35 |
| Azoxystrobin | 6.0 |
| PEG 300 | 30 |
| Potassium Humate | 4.0 |
| Water | 9.9 |
| TAEO | 4 |
| T-Mulz DP6E | 11 |
| RED = Ra/R₀ | 0.19 |
| pH | 4.5 |
| % Azoxystrobin (Fungicide) | 6.0 |
| % Humic Acid | 3.2 |

This composition provides the benefits of both the fungicide azoxystrobin and humic acid in one single product.

### Example 11

This example illustrates a formulation of humic acid with salicylic acid and PLURONIC L62 surfactant, a commercial product of the BASF Corporation. This surfactant is a difunctional ethylene oxide/propylene oxide block copolymer that is commonly used in soil wetting. A composition of potassium humate (80% humic acid), PLURONIC L62 surfactant, PEG 300 (a polyethylene glycol having a molecular weight of about 300), salicylic acid, and water was prepared as shown in Table 11.

TABLE 11
Composition with Salicylic Acid and Surfactant

| Composition # | 43 |
|---|---|
| PEG 300 | 15 |
| Potassium Humate (80% Humic Acid) | 2.5 |
| Water | 5.0 |
| PLURONIC L62 Surfactant | 75.0 |
| Salicylic Acid | 2.5 |
| RED = Ra/R₀ | 0.54 |
| pH | 4.5 |
| % Salicylic Acid | 2.5 |
| % Humic Acid | 2.0 |

This composition provides the benefits of three components, humic acid, salicylic acid, and a soil wetting surfactant, in one single product.

### Example 12

This example illustrates the formulation of a humic acid composition containing potassium humate (80 wt. % humic acid), PEG 300 (a polyethylene glycol having a molecular weight of about 300), tallow amine ethoxylate (TAEO), water, citric acid, and salicylic acid as shown in Table 12. This composition was then used in field trials described in Examples 13 and 14.

TABLE 12
Composition for Field Trials

| Composition # | 44 |
|---|---|
| PEG 300 | 10 |
| TAEO | 10 |
| Potassium Humate | 10 |
| Water | 60 |
| Citric Acid | 10 |
| Salicylic Acid | 6 |
| pH | 4.0 |
| % Humic Acid | 8 |

### Example 13

This example illustrates a field trial to determine the effect of applying the humic acid composition number 44 described in Example 12 on lettuce.

A field trial was conducted with the humic acid composition of Example 12 on iceberg lettuce grown in Watsonville, Calif. for bulk processing in bagged salads. Plants were grown in five lines on 80 inch beds. Each plot was 30 feet of one bed. The first application occurred just prior to thinning. This is also typical timing for a side dressed fertilizer application. Foliar applications were made using a CO₂ powered backpack sprayer. Soil applications were made with a 2.5 gallon watering can. Product was applied in a one gallon solution in two strips down the bed. An additional 7.5 gallons were added over the top to help move the solution into the soil. Table 13A

The second application was around the eight leaf stage when small heads were just starting to form. Harvest evaluation was done about two days before actual harvest. Three five foot sections of each bed were evaluated. Within each section, all heads were cut and stripped similar to how a harvest crew would. The total weight in pounds per each five foot row section were taken. The results are shown in Table 13.

TABLE 13
Results of Lettuce Field Trials

| Trial | Treatment | Application | Rate of | Total Mean |
|---|---|---|---|---|
| No. | Composition | Type | Application | Weight |
| 1 | None | n/a | n/a | 25.2 |
| 2 | Composition 44 | Not treated | 2 gallons/acre | 28.0 |
| 3 | Composition 44 | Soil applied | 2 quarts/acre | 27.5 |

For total mean weight within each five foot row section, both soil and foliar applied applications of composition #44 were greater than the untreated. The soil applied humic acids performed slightly better than the foliar applied humic acids.

Additionally, root samples were taken from 8 random plants within the untreated and two soil applied treatments. A small shovel was used to take plug samples of soil six inches in diameter and eight inches deep. Soil was shaken loose in the field and roots were washed clean the next day. Although no direct measurements were captured visually, there was an obvious increase in root mass and lateral fine roots for lettuce treated with composition #44 over the control.

### Example 14

This example illustrates a field trial to determine the effect of applying the humic acid composition number 44 of Example 12 on broccoli.

For the root and shoot weights, twelve random plants per plot about one inch above the soil were selected and weighed in the field. Root samples were also taken. Soil was shaken loose in the field and roots were washed clean the next day. Each sample was then cut at the shoot/root division and the roots were allowed to dry for 48 hours before being weighed. The results of the field trial are shown in Table 15.

TABLE 14
Results of Broccoli Field Trials

| | Shoot | Root dry | Root to shoot ratio |
|---|---|---|---|
| Treatment | biomass (lb) | mass (g) | (g/lb) |
| Untreated | 7.875 | 26.7 | 3.390 |
| Composition #44 | 7.958 | 35.2 | 4.423 |
| (2 gallons/acre) | | | |
| Composition #44 | 7.851 | 30.2 | 3.849 |
| (2 quarts/acre) | | | |

The results show that this composition increased the root dry mass and the root to shoot ratio of the broccoli in the trial.

I claim:

1. A humic acid composition comprising a solution of about 0.1 to 25 parts by weight humic acid dissolved in about 75 to 99.9 parts by weight of a solvent, the solvent comprising at least one nonaqueous solvent, the composition having a pH of about 1 to 7 and a RED of less than about 1.0.

2. The humic acid composition of claim 1 wherein the solvent additionally comprises water.

3. The humic acid composition of claim 2 wherein the solvent comprises about 10 to 99 parts by weight of at least one nonaqueous solvent and about 1 to 90 parts by weight water.

4. The humic acid composition of claim 2 wherein the solvent comprises about 25 to 90 parts by weight of at least one nonaqueous solvent and about 10 to 75 parts by weight water.

5. The humic acid composition of claim 3 wherein the RED is less than about 0.9.

6. The humic acid composition of claim 3 additionally comprising an effective amount of a surfactant.

7. The humic acid composition of claim 3 wherein the nonaqueous solvent comprises a polyethylene glycol, ethylene glycol, propylene glycol, an alcohol, a sugar alcohol, a polyglycerol, a glycol ether, an amine based solvent, an amide based solvent, an alkylene carbonate, an organic acid, or an inorganic acid.

8. The humic acid composition of claim 7 wherein the nonaqueous solvent comprises a polyethylene glycol.

9. The humic acid composition of claim 3 wherein the RED is less than about 0.8.

10. The humic acid composition of claim 3 additionally comprising an effective amount of a fungicide.

11. The humic acid composition of claim 3 additionally comprising an effective amount of a herbicide.

12. The humic acid composition of claim 3 additionally comprising an effective amount of an insecticide.

13. The humic acid composition of claim 3 additionally comprising an effective amount of a plant growth regulator.

14. The humic acid composition of claim 3 additionally comprising an effective amount of an antioxidant.

15. The humic acid composition of claim 3 additionally comprising an effective amount of an amino acid.

16. The humic acid composition of claim 3 additionally comprising an effective amount of nitrogen, phosphorus, potassium, calcium, magnesium, sulfur, iron, manganese, copper, zinc, molybdenum, chlorine, or boron.

17. A humic acid composition comprising a solution of about 0.1 to 25 parts by weight humic acid dissolved in about 75 to 99.9 parts by weight of a solvent, the solvent comprising about 10 to 75 parts by weight water and about 25 to 90 parts by weight of at least one nonaqueous solvent, the composition having a pH of about 4 to 6 and a RED of less than about 1.0.

18. A humic acid composition comprising a solution of about 1 to 15 parts by weight humic acid dissolved in about 85 to 99 parts by weight of a solvent, the solvent comprising water and at least one nonaqueous solvent, the composition having a pH of about 1 to 7 and a RED of less than about 0.7.
